(19) United States
(12) Patent Application Publication
(10) Pub. No.: US 2017/0306159 A1
(43) Pub. Date: Oct. 26, 2017

(54) PVD METAL EFFECT PIGMENT POWDER

(71) Applicant: SCHLENK METALLIC PIGMENTS GmbH, Roth-Barnsdorf (DE)

(72) Inventors: Christian LANG, Roth (DE); Nina LANG, Erlangen (DE); Fabian PIECH, Wendelstein (DE); Frank J. MAILE, Roth (DE); Thomas MÜLLER, Heideck (DE)

(21) Appl. No.: 15/518,268

(22) PCT Filed: Oct. 13, 2015
(86) PCT No.: PCT/EP2015/073642

§ 371 Date: Apr. 11, 2017

(30) Foreign Application Priority Data
Oct. 13, 2014 (DE) 10 2014 015 151.4

(51) Int. Cl. C09C 1/00; C09D 7/12

(52) U.S. Cl. CPC C09C 1/0021; C09D 7/1216; C01P 2004/86; C09C 2200/1058; C01P 2006/12; C09C 2210/60; C09C 2200/407

(57) ABSTRACT

The invention relates to powder made of coated PVD metal effect pigment, highly concentrated suspensions of coated PVD metal effect pigment as well as the use thereof in powder lacquers and masterbatches. The powder according to the invention made of coated PVD metal effect pigments is characterized by a very good redispersibility and is outstandingly suitable in particular for the preparation of highly concentrated suspensions. Furthermore, it is very free flowing, substantially agglomerate-free and results in coatings with excellent metallic gloss.

The invention relates to powder made of coated PVD metal effect pigment, highly concentrated suspensions of coated PVD metal effect pigment as well as the use thereof in powder lacquers and masterbatches. Furthermore, the invention relates to the use thereof for laser marking plastics.

Metal effect pigments are often used in lacquers, paints, printing inks, powder lacquers, cosmetics or plastics for colouring and in particular to produce a metallic effect.

Conventional metal effect pigments are flake-shaped metallic pigments, wherein the metallic effect depends on the directed reflection of incident light on the metallic pigments formed flat, which are aligned parallel in the coating.

In addition to conventional metal effect pigments, metal effect pigments which are produced by PVD processes (Physical Vapour Deposition) have been known for a long time. The production of metallic pigments by a PVD vapour deposition process is described, for example, in U.S. Pat. No. 2,839,378. In this process, a very thin metal layer is vapour-deposited on a substrate which has been provided with a “release layer” via a PVD process. After the application of the metal layer and dissolution of the film in solvents, the pigments are reduced to the desired particle size, usually via mechanical or ultrasonic treatment. Such metal effect pigments are characterized by an excellent gloss and unrivalled optical properties. The PVD pigments have a relatively homogeneous, small thickness (in the range of from 5 nm to 70 nm) and a very smooth surface with only very few surface defects and impart a high degree of light reflection. In particular on a smooth background, on which they can align themselves very evenly, the application of PVD pigments leads to a mirror-like appearance. Furthermore, PVD pigments are characterized by a high covering power.

At the present time, only PVD aluminium effect pigments are commercially available. These are usually supplied as dispersions with a solids content of aluminium pigment of from 10 to 20 wt.-%. Commercial examples of such aluminium pigments, which are produced by PVD processes, are, in particular, Decomet® (Schlenk), as well as Metasheen® or Metalure®.

As stated above, PVD aluminium effect pigments are usually available as low-concentration suspensions with aluminium pigment solids contents in the range of from 10 to 20 wt.-%.

Because of their extraordinary fineness, the large surface area associated therewith and the agglomeration properties, to date PVD pigment powders and highly concentrated PVD pigment suspensions with concentrations of 70 wt.-% or more have not been known.

Especially against the backdrop of ecological considerations and legal requirements, it is of great interest to provide a low-solvent PVD pigment dispersion in highly concentrated form or a solvent-free embodiment in the form of PVD pigment powder. The provision of such PVD pigment powders opens up new application possibilities such as the use in powder lacquers or in a plastics masterbatch.

The object of the present invention is to provide PVD metal effect pigments, which are present in powder form or in highly concentrated form. The PVD pigment powders should substantially be able to be obtained free from agglomerates and possess a good redispersibility. The object of the invention is, furthermore, the provision of a process for the production of such PVD metal effect pigment powders and highly concentrated suspensions.

The object is achieved by a powder made of coated PVD metal effect pigment, wherein the coated PVD metal effect pigment comprises a PVD metal effect pigment and a metal oxide layer, wherein the metal oxide layer amounts to 5 to 45 wt.-%, based on the total weight of the coated PVD metal effect pigment.

The object is furthermore achieved by a process, comprising the steps of:
a) coating metal effect pigments produced by PVD processes with metal oxide in a sol-gel process, wherein the metal oxide layer amounts to 5 to 45 wt.-%, based on the total weight of the coated PVD metal effect pigments,
b) solid-liquid separation of the coated metal effect pigments from the reaction mixture,
c) drying the coated metal effect pigments obtained at 100° C. to 140° C., wherein a powder is obtained.

It has surprisingly been shown that, by applying a metal oxide coating to a pigment produced by PVD in a quantity in the range of from 5 to 45 wt.-% and drying the separated-off pigments at 100° C. to 140° C., a powder can be obtained which has a very narrow particle size distribution, is substantially agglomerate-free and very free flowing. Surprisingly, despite their large surface area and their tendency to agglomerate, the metal oxide-coated (preferably SiO₂-coated) PVD metal effect pigments can be dried very well, whereby powders with very good properties can be obtained.

The powder according to the invention made of coated PVD metal effect pigments is characterized by a very good redispersibility and is outstandingly suitable in particular for the preparation of highly concentrated suspensions. Furthermore, it is very free flowing, substantially agglomerate-free and results in coatings with excellent metallic gloss.

The metal effect pigment in the powder according to the invention or the suspension according to the invention is a metal effect pigment produced by physical vapour deposition (PVD), which is also referred to within the framework of the present invention as PVD metal effect pigment. The metal is preferably selected from the group consisting of aluminium, magnesium, chromium, silver, copper, zinc, tin, manganese, iron, cobalt, zirconium, gold, titanium, iron, platinum, palladium, nickel, tantalum, molybdenum, steel as well as mixtures and alloys thereof, in particular consisting of aluminium, titanium, chromium, zirconium, copper, zinc, gold, silver, tin, steel, iron as well as alloys thereof and/or mixtures thereof, more preferably aluminium, titanium, chromium, zirconium, copper, zinc, gold, silver, tin as well as alloys and/or mixtures thereof.

Particularly preferably, the metal of the metal effect pigment is aluminium and alloys thereof as well as chromium, quite particularly preferably aluminium. The production of the PVD metal effect pigments is performed according to the processes usual in the state of the art, see for example U.S. Pat. No. 2,941,894 as well as U.S. Pat. No. 4,321,087, or also the established PVD processes as are described in “Vakuumbeschichtung Band 1-5” [Vacuum coating volumes 1-5] (VDI-Verlag, Ed. Kienel), in particular processes with or without reactive gas, resistance- or radiantly heated processes, electron beam technology etc.

According to the invention, the coated PVD metal effect pigment comprises a metal oxide layer, i.e. the PVD metal effect pigment is coated with a metal oxide layer. This is, in particular, a layer made of silicon dioxide, aluminium oxide, titanium dioxide, iron oxide, tin oxide, zinc oxide or mixtures thereof. Preferably, the metal oxide is silicon dioxide, which is subsumed under metal oxide within the framework of the present invention, since, within the framework of the present invention, metal oxide also comprises semimetal oxides in the widest sense. Two or more layers made of different oxides can also be applied. Preferably, the metal oxide layer is colourless. The metal oxide layer is preferably applied wet chemically, in particular according to a sol-gel process.

The metal oxide layer is applied after the production of the PVD metal effect pigments, i.e. the PVD metal effect pigments according to the invention are so-called aftercoated PVD metal effect pigments. The metal oxide layer is preferably applied wet chemically. The PVD metal effect pigments according to the invention are precisely not a multilayer PVD effect pigment in which both the metal layer and also a dielectric layer (e.g. a metal oxide layer) are applied by means of PVD processes, as described, for example, in WO2006/069663. Furthermore, the PVD metal effect pigments according to the invention preferably do not have the following layer structure: an aluminium oxide- or aluminium oxide/hydroxide-containing layer produced by wet chemical oxidation, a highly refractive metal chalcogenide layer with a refractive index greater than 1.95 and optionally an oxide layer made of a material with a refractive index smaller than 1.8 between them, wherein the aluminium oxide- or aluminium oxide/hydroxide-containing layer and the highly refractive metal chalcogenide layer or the aluminium oxide- or aluminium oxide/hydroxide-containing layer and the oxide layer made of a material with a refractive index smaller than 1.8 or all three layers together form a mixed layer.

These layers serve both as corrosion protection and also for chemical and physical stabilization. Particularly preferred are silicon dioxide layers which are applied according to the sol-gel process and which, in particular, also completely encase the metallic fracture edges. This process comprises the dispersion of the metallic pigments in a solution of a metal alkoxide such as tetraethyl orthosilicate (usually in a solution of organic solvent or a mixture of organic solvent and water with at least 50 wt.-% organic solvent such as a short-chain alcohol), and addition of a weak base or acid to hydrolyse the metal alkoxide, whereby a film of the metal oxide forms on the surface of the pigments. Such sol-gel processes are generally known, see e.g. The chemistry of Silica, Ralph Iler, Wiley and Sons, 1979, Gerhard Jonschker, Praxis der Sol-Gel-Technologie [Practice of sol-gel technology], Vincnetz Verlag, 2012. Decomet® pigments of the 1000 series are particularly preferably used. These are aluminium PVD pigments.

The metal oxide layer, which, on the one hand, contributes to a passivation of the highly reactive PVD metal effect pigments and, on the other hand, allows the pigment powder to dry well, amounts to 5 to 45 wt.-%, preferably 30 to 44 wt.-%, in particular 35 to 43 wt.-%, particularly preferably 37 to 42, and quite particularly preferably 39 to 40 wt.-%, based on the total weight of the coated metal effect pigment. The thickness of this metal oxide layer is usually between 2 and 100 nm.

In addition, the metal oxide layer can be modified by means of organic compounds such as silanes, phosphoric acid esters, titanates, borates or carboxylic acids, wherein these organic compounds are bound to the metal oxide layer. The organic compounds are preferably functional silane compounds, which can bind to the metal oxide layer. These can be either mono- or also bifunctional compounds. Examples of bifunctional organic compounds are methacryloxypropenyltrimethoxysilane, 3-methacryloxypropyltrimethoxysilane, 3-acryloxypropyltrimethoxysilane, 2-acryloxyethyltrimethoxysilane, 3-methacryloxypropyltriethoxysilane, 3-acryloxypropyltrimethoxysilane, 2-methacryloxyethyltriethoxysilane, 2-acryloxyethyltriethoxysilane, 3-methacryloxypropyltris(methoxyethoxy)silane, 3-methacryloxypropyltris(butoxyethoxy)silane, 3-methacryloxypropyltris(propoxy)silane, 3-methacryloxypropyltris(butoxy)silane, 3-acryloxypropyltris(methoxyethoxy)silane, 3-acryloxypropyltris(butoxyethoxy)silane, 3-acryloxypropyltris(butoxy)silane, vinyltrimethoxysilane, vinyltriethoxysilane, vinylethyldichlorosilane, vinylmethyldiacetoxysilane, vinylmethyldichlorosilane, vinylmethyldiethoxysilane, vinyltriacetoxysilane, vinyltrichlorosilane, phenylvinyldiethoxysilane, or phenylallyldichlorosilane.

Furthermore, a modification can take place with a monofunctional silane, in particular an alkylsilane or arylsilane. This has only one functional group which can bind covalently to the surface of the aftercoated metallic pigment (i.e. to the metal oxide layer) or, in the case of a not quite complete coverage, to the metal surface. The hydrocarbon residue of the silane points away from the pigment. Depending on the type and nature of the hydrocarbon residue of the silane, a different degree of hydrophobization of the pigment is achieved. Examples of such silanes are hexadecyltrimethoxysilane, propyltrimethoxysilane, etc.

Particularly preferred in the powder according to the invention or the suspension according to the invention are aluminium effect pigments coated with silicon dioxide, which are surface-modified with a monofunctional silane. Particularly preferred are octyltrimethoxysilane, octyltriethoxysilane, hexadecyltrimethoxysilane as well as hexadecyltriethoxysilane. Through the altered surface properties/hydrophobization, an improvement in the agglomerate-free drying, as well as a better alignment in the application can be achieved.

Furthermore, the coated PVD metal effect pigments can also be coated with a further layer, preferably a polymer layer, in particular made of (meth) acrylic resins. The use of a polymer layer, which preferably has poor solubility in water and solvents, can further improve the chemical stability of the pigments as well as the bonding in lacquers, if required.

The average particle size (D50 value) of the coated metal effect pigments according to the invention is usually in the range of 1 to 250 micrometres, preferably 2 to 150 micrometres and in particular 5 to 50 micrometres.

The BET surface area of the coated PVD metal effect pigments according to the invention is, in comparison with conventional silver dollar pigments or cornflake pigments, very large and is preferably in the range of from 15 to 90 m²/g, in particular 18 to 40 m²/g, more preferably 22 to 35 m²/g. The BET surface area is the specific surface area, measured in accordance with the BET method (DIN 66132). Because of the very large surface area of a PVD metal effect pigment (also referred to as VMPs) compared with a conventional pigment, the production of a VMP powder or a VMP paste is a major challenge. Within the framework of the present invention, however, it was possible to produce a PVD powder or a PVD paste or suspension with excellent properties.

The powder according to the invention made of coated PVD metal effect pigment is characterized by excellent redispersibility (assessed visually by homogeneous pasting, or grindometer) and free-flowing properties (derivable from bulk density DIN 53466, apparent density in accordance with DIN EN ISO 3923-1, flow rate in accordance with DIN EN ISO 4490).

The redispersibility is assessed as follows. The redispersion of the dried powder in the binder (e.g. medium A) takes place in a Speedmixer (DAC 250 SP device) over a period of 80 s at defined rotational speeds (1000 rpm for 10 s; 2000 rpm for 15 s; 2500 rpm for 30 s; 2000 rpm for 10 s; 1000 rpm for 5 s). The batch is spread with a 24 or 38 μm doctor blade and evaluated optically for agglomerates. The fewer agglomerates are formed, the better is the redispersibility. In addition, with the increase in the redispersibility an increase in the gloss is also to be observed. The gloss of the obtained coatings is determined either via a measurement (Tri-Gloss from Byk-Garner) or by visual comparison with the slurry obtained directly after the coating without drying and the dried material.

Furthermore, the obtained powder is examined with respect to its particle size distribution (e.g. with the Helos particle size measuring device from Sympatec using laser diffraction, wet measurement, d50 values known; e.g. D10=6.58 μm; D50=14.77 μm; D90=26.66 μm; span=1.36). The spreading, the methodology of which is described in more detail in the experimental section, has also proven to be suitable for the further assessment. In the spreading and the particle size distribution it can be seen whether the dried powder is agglomerate-free. The quality of the obtained powder made of coated PVD metal effect pigment can also be seen from the dispersibility of the powder.

The present powder according to the invention is a uniform fine-grained powder. Coatings in which the powder according to the invention made of coated PVD metal effect pigment was used in the form of the powder or in the form of a suspension show a very good metallic gloss. The present invention thus makes it possible to provide a novel embodiment of the PVD metal effect pigments, which is, in ecological and production-related terms, very advantageously low-solvent or solvent-free, wherein a similar metallic gloss can be achieved to that from PVD metal effect pigments made of low-concentration suspensions.

It is understood that the features named above and those yet to be explained below can be used not only in the stated combinations but also in other combinations or alone, without departing from the scope of the present invention. This is true in particular for the specifically named metal effect pigments, the metal oxide layers, the modification agents, the process parameters and the respective quantities of the different features, the various combinations of which are to be regarded as disclosed according to the invention.

Preferably the PVD metal effect pigment powder according to the invention is used in a powder lacquer. Powder lacquers are organic, mostly thermosetting coating powders with a solids content of 100%. For powder lacquers, reactive binder polymers are used, which can crosslink either with each other or via a crosslinking agent to form branched macromolecules. Within the framework of the present invention, usual powder lacquer binders can be used, in particular epoxy resins, carboxy and hydroxy group-containing polyesters, OH- and GMA-acrylic resins, as well as modified resins for specific fields of application. Furthermore, usual additives such as levelling agents, structuring agents, waxes and fillers can be used. The quantity of powder according to the invention made of coated PVD metal effect pigment is in the range of from 0.01 to 2 wt.-%, preferably 0.2-0.8%. The curing of the powder lacquers on the substrate can be performed by stoving or using radiation energy.

These powder lacquers can be used in particular in metal coating, domestic appliances, claddings, furniture painting and automobile painting.

A suspension of coated PVD metal effect pigment in a solvent (preferably a medical white oil) also belongs to the invention, wherein the coated PVD metal effect pigment comprises a PVD metal effect pigment and a metal oxide layer, wherein the metal oxide layer amounts to 5 to 45 wt.-%, based on the total weight of the coated metal effect pigment, characterized in that the suspension contains 70 wt.-% or more coated PVD metal effect pigment. The content of coated PVD metal effect pigment is preferably 75 wt.-% or more, more preferably 80 wt.-% to 99 wt.-% or preferably 85 wt.-% to 97 wt.-%, preferably 90 wt.-% to 95 wt.-%. Usual solvents such as medical white oils, e.g. Shell Ondina oil 941, can be used as solvents for the suspension. Surprisingly, such highly concentrated suspensions can be prepared from the powder according to the invention without problems, and they are characterized by good dispersion and stability properties, and result in coatings with very good metallic gloss. Such highly concentrated suspensions can also be referred to as pastes. Part of the invention is therefore also a paste of coated PVD metal effect pigment in a solvent (preferably a medical white oil), wherein the coated PVD metal effect pigment comprises a PVD metal effect pigment and a metal oxide layer, wherein the metal oxide layer amounts to 5 to 45 wt.-%, based on the total weight of the coated metal effect pigment, characterized in that the paste contains 70 wt.-% or more coated PVD metal effect pigment.

Further preferred uses of a PVD metal effect pigment suspension or of a PVD metal effect pigment powder are in paints, lacquers, masterbatches, printing inks, plastics, cosmetic preparations, in security printing or printing securities. Because of their decorative metallic gloss (chrome-like gloss) they are predestined in particular for the printing industry, the field of decorative lacquers, cosmetics and the security field.

Part of the invention are furthermore powder lacquers containing a PVD metal effect pigment powder according to one of the preceding claims.

Protected according to the invention is furthermore a masterbatch containing a PVD metal effect pigment powder according to one of the preceding claims and a plastic. By the term masterbatch is meant generally plastic additives in the form of granules with colorant contents which are higher than in the final application. Masterbatches increase the process reliability compared with pastes, powders or liquid additives and they can be processed very well. They are mixed with the plastic (raw polymer) for colouring. Within the framework of the present invention, all natural or synthetic polymers which can be mixed with a metal effect pigment are suitable as plastics. Prominent examples are e.g. polyolefins, in particular PE, PP, polyamides, polyesters, polyacrylates, polycarbonates etc. Particularly suitable are polypropylenes (PP). Such masterbatches can in particular also be used for packaging materials, such as for example cosmetic packaging, in which the chrome-like effects obtained are particularly desirable.

The quantity of coated PVD metal effect pigment (in the form of the powder or as a highly concentrated suspension in oil) in the masterbatch according to the invention is 1.5 to 5 wt.-%, preferably 2.5 to 3%, based on the solid.

Surprisingly it was established that the coated PVD metal effect pigments exhibit an unexpectedly good alignment in the plastic. In particular, compared with lacquer application, no curling/rippling of the coated PVD metal effect pigments in the plastic was established (TEM measurement).

Part of the invention is thus also a plastic material, in which a powder according to the invention or a suspension according to the invention (or a paste according to the invention) is contained in a plastic (raw polymer). This can be produced either by mixing a masterbatch as described above with a plastic or by mixing a plastic with a powder according to the invention or a suspension according to the invention.

Furthermore, it could be established that the coated PVD metal effect pigments in the plastic are eminently suitable for laser marking, in particular a type of cold marking. By using a transparent polymer as plastic and the coated PVD metal effect pigments (introduced as masterbatch) as laser-sensitive component, carbonization is induced in the polymer matrix by the laser irradiation, which causes a type of foaming, with the result that gas bubbles float up. A marking is thereby caused which, however, is not noticeable on the surface (a type of cold marking). Here, for example PPs are suitable as polymers. Suitable lasers are well-known to a person skilled in the art and comprise, for example, YAG lasers (1064 nm).

Part of the invention are thus also the use of a masterbatch according to claim 13 or 14 or of a plastic material according to claim 15 for laser marking a plastic. Furthermore, a method for laser marking a plastic, comprising the provision of a masterbatch according to claim 13 or 14 or of a plastic material according to claim 15, and irradiation with laser light of a selected area of the plastic with the result that the laser-sensitive coated PVD metal effect pigments (preferably SiO₂-coated aluminium PVD pigments) are transformed at least partially in this area, also belongs to the invention. The preferred embodiments described above of the powder according to the invention, the suspension according to the invention, the masterbatch according to the invention and the coated PVD metal effect pigments according to the invention used therein in each case also apply in particular, in each case individually and also in combination, for the use for laser marking and the method for laser marking plastics. The laser-sensitive coated PVD metal effect pigment is one which comprises a PVD metal effect pigment and a metal oxide layer, wherein the metal oxide layer amounts to 5 to 45 wt.-%, preferably 30-44 wt.-%, based on the total weight of the coated PVD metal effect pigment. Particularly preferably, an aluminium PVD effect pigment is used with a silicon dioxide layer as metal oxide layer, which amounts to 5 to 45 wt.-%, preferably 30-44 wt.-%, based on the total weight of the coated PVD aluminium effect pigment.

It was established namely that the coated PVD metal effect pigments according to the invention, which are preferably SiO₂-coated aluminium PVD pigments, are much better suited for laser processing than uncoated Al PVD pigments. In the case of irradiation with a laser, from the SiO₂-coated aluminium PVD pigments so-called “melting beads” with a size range from approx. 5 to 150 nm are formed in a polypropylene matrix, which only scatter slightly in the visible spectral range. Thereby, the marked area, for example in the form of lettering, looks largely transparent. In contrast thereto, uncoated Al flakes result in “melting beads” with a size range from approx. 5 to 600 nm, which scatter more strongly in the visible spectral range. The laser-marked areas in this case look translucent. Without wishing to be limited to this, EDX analyses of the “melting beads” of SiO₂-coated aluminium PVD pigments appear to suggest that a largely homogeneous distribution of Al, Si, Ca and O is present in the “melting beads”, which could suggest evidence of a ternary or quaternary phase A-Si—O—(Ca). The melting beads are, furthermore, predominantly spherical structures, which are partially built up in the form of shells. Optionally, the ternary or quaternary phase A-Si—O—(Ca) could be responsible for the smaller bead size through reduction of the coarsening through higher energy dissipation. In the case of uncoated Al flakes, in contrast, EDX analyses show a largely homogeneous distribution of Al and O, and only small traces of Si and Ca.

Aluminium pigments coated according to the invention appear to be subject to a surprising new mechanism in the case of laser marking in plastics. Advantageous therein is that the areas processed by lasers are largely transparent and have a smooth surface, i.e. do not have a different surface feel from the surrounding non-laser marked areas. As plastics, polyolefins, in particular PE and PP, polyamides, polyesters, polyacrylates, polycarbonates etc., as well as also high-temperature resistant polymers such as polyether sulfones, polyamide-imides and polyether ether ketones are suitable. Particularly suitable are polypropylenes (PP). The plastics can contain usual additives such as stabilizers, plasticizers, fillers, reinforcing substances and further colorants or coloured pigments.

Such markings in the form of lettering, graphical or symbolic markings are suitable for quite different areas of use. They are particularly suitable for packaging of any type, in particular also for packaging for cosmetic articles and for foodstuffs. The plastic material to be marked can be, for example, a shaped body (deep-drawn, blow moulded or also stripped) as well as a film or a lacquer. If the plastic contains further coloured pigments or colorants in addition to the coated metal effect pigments according to the invention, for example very high-quality, coloured and shiny metallic marked objects can be obtained.

Part of the invention are therefore also laser-marked plastics, which were produced according to the process according to the invention, and which are optionally present in the form of shaped bodies, films, lacquers or coatings.

Part of the invention is furthermore a process for the production of a PVD metal effect pigment powder, comprising the steps of:
a) coating metal effect pigments produced by PVD processes with metal oxide in a sol-gel process, wherein the metal oxide layer amounts to 5 to 45 wt.-%, based on the total weight of the coated PVD metal effect pigments,
b) solid-liquid separation of the coated metal effect pigments from the reaction mixture,
c) drying the coated metal effect pigments obtained at 100° C. to 140° C., wherein a powder is obtained.

In step a), the PVD metal effect pigments produced according to the processes known in the state of the art are coated according to a sol-gel process, preferably with an SiO₂ layer. This process comprises the dispersion of the metallic pigments in a solution of a metal alkoxide such as tetraethyl orthosilicate (usually in a solution of organic solvent or a mixture of organic solvent and water with at least 50 wt.-% organic solvent such as a short-chain alcohol), and addition of a weak base to hydrolyse the metal alkoxide, whereby a film of the metal oxide forms on the surface of the pigments. Sol-gel processes are known to a person skilled in the art, as already stated above. Decomet® pigments of the 1000 series are particularly preferably used. The preferred embodiments in respect of preferred components, modifying processes and weight data listed above in connection with the product claims also apply for the present process.

In step b) of the process according to the invention, the coated pigment particles are separated off with the aid of a solid-liquid separation. This can be performed using different techniques, in particular by centrifuging, decanting and filtering off. The pigment particles are preferably filtered off. The filtering off preferably takes place by means of a suction filter (in particular glass frits) at room temperature. By applying a vacuum, a solid of 5-35% (solids content based on the composition of the slurry) is obtained over a period of from 1 min to 60 min.

The obtained particles can be further washed with ethanol or other solvents, or immediately subjected to the drying step c).

The drying takes place at a temperature of 100° C. to 140° C., preferably at 110° C. to 130° C., particularly preferably 115° C. to 125° C., quite particularly preferably at 120° C. A kiln is preferably used, in particular a rotary kiln etc., however, other drying kilns or laboratory kilns can also be used such as the laboratory kiln from Memmert Universal Oven UF110plus or Ultramat from Sartorius M35. The drying step is preferably performed in 6 h to 18 h, in particular 10 to 14 h.

It was established that drying at below 100° C. results in an undesired agglomeration formation, while in the case of drying at above 140° C. the possibly still adhering residues of the release coating from the PVD effect pigment production process lead to undesired side effects. Surprisingly, despite their large surface area and their tendency to agglomerate, the metal oxide-coated (preferably SiO₂-coated) PVD metal effect pigments can be dried very well, whereby powders with very good properties can be obtained.

The powder according to the invention made of coated PVD metal effect pigment is characterized, as discussed above, by excellent redispersibility and free-flowing properties.

The following examples explain the invention further.

### REFERENCE EXAMPLE 1

200 g Decomet 1002/10 (with 10% solids content) from Schlenk Metallic Pigments GmbH is suspended in 400 g isopropanol. 47 g tetraethoxysilane is added to this mixture and this mixture is heated to 60° C. Then, 100 g water followed by 6 g ammonia are added and the mixture is stirred for a further 4 h. The mixture is then filtered off via a glass frit. The filter cake obtained is then adjusted to 10% with isopropanol. The metal oxide layer amounts to 40 wt.-%, based on the total weight of the coated PVD metal effect pigment.

### EXAMPLE 2

200 g Decomet 1002/10 from Schlenk Metallic Pigments GmbH is suspended in 400 g isopropanol. 47 g tetraethoxysilane is added to this mixture and this mixture is heated to 60° C. Then, 100 g water followed immediately by 6 g ammonia are added and the mixture is stirred for a further 4 h. The mixture is then filtered off via a glass frit. The filter cake obtained is then dried in a drying kiln at 120° C. for 12 h. The metal oxide layer amounts to 40 wt.-%, based on the total weight of the coated PVD metal effect pigment.

### EXAMPLE 3

200 g Decomet 1002/10 from Schlenk Metallic Pigments GmbH is suspended in 400 g isopropanol. 47 g tetraethoxysilane is added to this mixture and this mixture is heated to 60° C. Then, 100 g water followed immediately by 6 g ammonia are added and the mixture is stirred for a further 4 h. The mixture is then filtered off via a glass frit. The filter cake obtained is then dried in a drying kiln at 120° C. for 12 h. The metal oxide layer amounts to 40 wt.-%, based on the total weight of the coated PVD metal effect pigment.

Then, pasting takes place in a Speedmixer with Ondina oil to form an 80% suspension (this highly concentrated suspension can also be referred to as paste).

The obtained powders, highly concentrated suspensions and low-concentration slurries were then examined.

Instructions for Spreading the Obtained Powders/Suspensions from Examples 2 and 3:

0.2 g of the dried powder is placed in a 25 ml plastic beaker with 1.8 g isopropanol. To this dispersion is added 3 g of the binder medium A (a nitrocellulose-based lacquer). The mixture is dispersed in a Speedmixer (device: DAC 250 SP) with a rotational speed (1000 rpm for 10 s; 2000 rpm for 15 s; 2500 rpm for 30 s; 2000 rpm for 10 s; 1000 rpm for 5 s), mixed through briefly once again with a spatula and then spread on the substrate on a coated paper with a 24 μm spiral blade. The spreading dries after five minutes at room temperature and can then be measured with a reflectometer (Tri-Gloss from Byk-Gardner). The agglomerate formation is determined visually.

Instructions for Spreading the 10% Slurry from Reference Example 1:

To 2 g of the slurry (10%) is added 3 g of the binder medium A. The mixture is dispersed in a Speedmixer (device: DAC 250 SP) with a rotational speed (1000 rpm for 10 s; 2000 rpm for 15 s; 2500 rpm for 30 s; 2000 rpm for 10 s; 1000 rpm for 5 s), mixed through briefly once again with a spatula and then spread on the substrate on a coated paper with a 24 μm spiral blade. The spreading dries after five minutes at room temperature and can then be measured with a reflectometer (Tri-Gloss from Byk-Gardner). The agglomerate formation is determined visually.

### Instructions Bulk Weight:

By measuring the weight of a predetermined volume of aluminium powder, the bulk weight or the bulk density of an aluminium powder is determined with the units g/ml or g/cm3.

A measuring cylinder made of brass (contents 50 ml) is placed on the scales and tared to 0. A sufficient quantity of aluminium powder is placed on an ounce paper (Pergamyn Echo, 35 g/m², unbleached, glazed) and carefully loosened crosswise (3×) using a spatula. The powder is now introduced slowly into the metal cylinder, which is standing on a paper, skimmed with a metal sheet and weighed.

The assessment takes place using the following equation:

$$\frac{Original sample weight [ g ]}{50 ml volume} = Bulk weight [ g \text{/} ml ]$$

The following test results were obtained.

### Comparison of Gloss, Bulk Weight

| | Gloss 60° | Bulk weight |
|---|---|---|
| Ref. Ex. 1 | 109.8 | — |
| Ex. 2 | 95.3 | 0.0384 |
| Ex. 3 | 93.5 | — |

### Comparison of Particle Size Distribution

| | D10 | D50 | D90 | span |
|---|---|---|---|---|
| Ref. Ex. 1 | 6.06 μm | 13.35 μm | 22.75 μm | 1.25 |
| Ex. 2 | 6.58 μm | 14.77 μm | 26.66 μm | 1.36 |
| Ex. 3 | 6.21 μm | 13.50 μm | 23.18 μm | 1.26 |

A comparison of the gloss values shows that on drying the 40% coated material according to the invention (Examples 2 and 3), only a small deviation in gloss occurs in comparison with the reference material from reference example 1. In the case of only small coating quantities below 5 wt.-%, it had been shown that on drying the material, a significant decrease in the gloss occurs compared with the undried material. This shows that the 40% coated material substantially retains the optical properties of the starting material, while on drying a less than 5% material, a significant decrease in the gloss occurs compared with the undried material. The coated and dried material according to the invention is furthermore convincing with its narrow particle size distribution and good redispersibility. From the PSD values it can be seen that no substantial increase in particle size occurs even after a 40% coating with SiO₂.

With the present invention it is therefore possible to obtain the advantages of powder forms and highly concentrated suspensions, wherein the good optical properties of such pigments are substantially retained.

As already observed above, because of the very large surface area of a PVD compared with a conventional pigment, the production of a PVD powder or a PVD paste is a major challenge. In the following table, the specific surface areas of a highly concentrated PVD powder compared with pigment powders of conventional silver dollar and cornflake pigments are represented to make this clearer.

| | BET surface |
|---|---|
| Pigment | area (m²/g) |
| Powdal ® 3200 (silver dollar) | 1.17 |
| Powdal ® 3400 (silver dollar) | 1.57 |
| Powdal ® 2900 (cornflake) | 10.9 |
| Decomet SiO2 (from Ex. 2) | 24.4 |

1-20. (canceled)

21. A powder made of a coated PVD metal effect pigment, wherein the coated PVD metal effect pigment comprises a PVD metal effect pigment and a metal oxide layer, wherein the metal oxide layer amounts to 5 to 45 wt.-%, based on the total weight of the coated PVD metal effect pigment.

22. The powder according to claim 21, characterized in that the metal oxide layer comprises silicon dioxide, aluminium oxide, titanium dioxide, iron oxide, tin oxide, zinc oxide or mixtures thereof, and/or wherein the metal oxide layer was applied wet chemically.

23. The powder according to claim 21, wherein the metal oxide layer amounts to 30 to 44 wt.-%, based on the total weight of the coated PVD effect pigment.

24. The powder according to claim 21, characterized in that a bifunctional or monofunctional organic compound comprising a silane is bound to the metal oxide layer.

25. The powder according to claim 21, wherein the metal effect pigment comprises a metal made of aluminium, titanium, chromium, zirconium, copper, zinc, gold, silver, tin, steel, iron as well as alloys thereof and/or mixtures thereof.

26. The powder according to claim 21, wherein the metal effect pigment comprises a metal made of aluminium, titanium, chromium, zirconium, copper, zinc, gold, silver, tin as well as alloys thereof and/or mixtures thereof, and/or wherein the BET surface area of the coated PVD metal effect pigment is between 15 and 90 m²/g.

27. The powder according to claim 21, wherein the PVD metal effect pigment is an aluminium effect pigment coated with an SiO₂ layer, wherein the SiO₂ layer amounts to 5 to 45 wt.-% of the total weight of the coated PVD metal effect pigment.

28. A powder lacquer comprising the powder according to claim 21.

29. A suspension comprising a coated PVD metal effect pigment suspended in a solvent, wherein the coated PVD metal effect pigment comprises a PVD metal effect pigment and a metal oxide layer, wherein the metal oxide layer amounts to 5 to 45 wt.-%, based on the total weight of the coated PVD metal effect pigment, characterized in that the suspension comprises 70 wt.-% or more of the coated PVD metal effect pigment.

30. The suspension according to claim 29, characterized in that a weight percent of the coated PVD metal effect pigment in the suspension is 75 wt.-% or more, and/or the solvent is a medical white oil.

31. The suspension according to claim 29, wherein the PVD metal effect pigment is an aluminium effect pigment coated with an SiO₂ layer, wherein the SiO₂ layer amounts to 5 to 45 wt.-% of the total weight of the coated PVD metal effect pigment.

32. A masterbatch comprising solid granules formed from a composition comprising: a PVD metal effect pigment, a coating of a metal oxide layer provided to the PVD metal effect pigment, wherein the metal oxide layer amounts to 5 to 45 wt.-%, based on a total weight of the coated PVD metal effect pigment, and a plastic.

33. The masterbatch according to claim 32, wherein the plastic is selected from polypropylene, polyamide and polycarbonate.

34. A process for producing a PVD metal effect pigment powder, comprising the steps of:
a) coating metal effect pigments produced by PVD processes with metal oxide in a sol-gel process, wherein the metal oxide layer amounts to 5 to 45 wt.-%, based on the total weight of the coated PVD metal effect pigments,
b) solid-liquid separation of the coated metal effect pigments from the reaction mixture,
c) drying the coated metal effect pigments obtained at 100° C. to 140° C., wherein a powder is obtained.

35. The process according to claim 34, wherein the PVD metal effect pigment is an aluminium effect pigment and the metal oxide layer is an SiO₂ layer, wherein the SiO₂ layer amounts to 5 to 45 wt.-%, preferably 30 to 44 wt.-%, based on the total weight of the coated PVD metal effect pigment.

36. The process according to claim 34, wherein the drying in step c) is performed in a rotary kiln at 120° C.
